(19) United States
(12) Patent Application Publication
(10) Pub. No.: US 2012/0226729 A1
(43) Pub. Date: Sep. 6, 2012

(54) POWER PLANT HAVING A CHEMICAL REACTION CYCLE

(76) Inventor: Hamid Reza SADEGHI, Wien (AT)

(21) Appl. No.: 13/354,047

(22) Filed: Jan. 19, 2012

Related U.S. Application Data
(63) Continuation-in-part of application No. 13/383,234, filed on Jan. 10, 2012.

(30) Foreign Application Priority Data
Jul. 16, 2009 (AT) A 1121/2009

(51) Int. Cl. G06F 7/38

(52) U.S. Cl. 708/443

(57) ABSTRACT

Disclosed is a method for measuring change in closed system, characterized in that, (the thesis): the partial differential equation the closed system ƒ(z) as a substitution or map onto a fixed point space such as closed band gap J,

ƒ(z):J→J gives g=ƒ(g) if g εJ,

if this partial differential equation ƒ(z) contains the partial derivatives of a function system in several variables

ƒ(z)=ƒ(N,T,E, ∂E/∂N, ∂E/∂T, . . . )

such as function E(N,T) in two independent variables, could be on a closed pathway.

$${\int }_{Initial}^{Final .} f ( z ) \cdot d z \neq 0$$

The present invention relates to a general answer for measuring change in a closed system, this process making possible a control of the system.

The information below was established to answer the following question:

Energetics: How can one produce energy in a closed system?

The partial differential equation the closed system ƒ(z) as a substitution or map onto a fixed point space such as a closed band gap J,

ƒ(z): J→J gives g=ƒ(g) if g εJ,

If a partial differential equation ƒ(z) contains the partial derivatives of a function system in several variables

ƒ(z)=ƒ(N,T,E, ∂E/∂N, ∂E/∂T, . . . )

such as function E(N,T) in two independent variables, could be on a closed pathway.

$${\int }_{Initial}^{Final .} f ( z ) \cdot d z \neq 0$$

Proof:

A partial differential equation ƒ(z) defines the function of energy change E(N,T) in a closed system

N—Variable for mass,

T—Variable for velocity,

ƒ(z)=E (N,T)

dƒ(z)=dEsys.=(∂E/∂N)·dN+(∂E/∂T)·dT=L(N,T)·dN+M(N,T)·dT

According to the Law of Green (in a plane) and Cauchy, ∂L/∂T=∂M/∂N should be implied→ƒ(z) is on simple closed curve C independent of pathway→The exact differential→∫ƒ(z)·dz=0

Often, however, ∂L/∂T≠∂M/∂N, i.e., ƒ(z) remains dependent on the pathway and ƒ(z) can be indifferentiable; ∂ (μL)/∂T=∂(μM)/∂N can be produced independently:

μ.∂L/∂T+L∂μ/∂T=μ. ∂M/∂N+M. ∂μ/∂N→

M. ∂μ/∂N−L. ∂μ/∂T=μ. ∂L/∂T−μ. ∂M/∂N→

1/μ. (M ∂μ/∂N−L ∂μ/∂T)=∂L/∂T−∂M/∂N , ∂μ(N)t/∂T=0 →

There are two possibilities for μ(N,T)=μ(N)t·μ(T)n

(dLn μ(N)t/dN)·M=(∂L∂T−∂M/∂N)

(dLn μ(T)n/dT)·L=(∂M/∂N−∂L∂T)

dLn μ(N)t/dN=(∂L/∂T−∂M/∂N)=g(N)t∂g(N)t/∂Tsys=0

dLn μ(T)n/dT=(∂M/∂N−∂L∂T)/L=f(T)n→∂f(T)n/∂Nsys=0

ΔEsys=±(ΔEᵢₙᵢₜᵢₐₗ−ΔE_{Final})·Nsys→

ΔEsys=±(ΔE(T)n. Nsys−ΔE(N)t·Nsys)→

ΔEsys=±(ΔE(T)n−ΔE(N)t·Nsys)

ΔE(N)t—Energy unit production for Nsys in the control region, dependent

66 E(T)n—The total energy consumption for Nsys in the process region, independent

If Nsys=ΔE(T)n/ΔE(N)t→ΔEsys=0→∫ƒ(z)·dz=0, Parabolic

If Nsys<ΔE(T)n/ΔE(N)t→ΔEsys>0→∫ƒ(z)·dz>0, Hyperbolic

If Nsys>ΔE(T)n/ΔE(N)t→ΔEsys<0→∫ƒ(z)·dz<0, Elliptic

In a closed system, water is decomposed; the energy consumption corresponds to 366 kJ/mol; then if the component of decomposed water is combined, energy of up to −285.8 kJ/mol is given to this process;
how is the energy of the system maintained? If the Nsys is set at 500.

(Mol)_{component}=Nsys * (coefficient)_{component}

Here, in this model, the pathway defines the mass

ΔEsys=366 kJ/mol−500. 285.8 kJ/mol

ΔEsys=−142534 kJ/mol.

Esys.=E (N,T)=0 with equilibrium, differentiable, independent of pathway

Esys.=E (N,T) ≠0 without equilibrium, undifferentiable, dependent on pathway

for example:

$${\int }_{Initial}^{Final .} f ( z ) \cdot d z = 0 The exact differential$$

If there is a small change in the system, the equilibrium energy of the system (the system freedom) could change enormously, since

Esys.=E(N,T)≠0 can→Esys.·μ=0,

If Esys. ·(μ(N)t·μ(T)n)=0

Then μ is an integral factor for the energy equation of the function, and could be viewed as an enormous change in the system. A reason for this is the form of the simple general answer that the integral factor for the energy function of the system appears in exponential form, and one can find the integral factor of the system by means of the system function; here find the integral factor for the energy function of the system:

Esys.=E(N,T);

dEsys.=(∂E/∂N)t·dN+(∂E/∂T)n·dT;

If L=(∂E/∂N)t und M=(∂E/∂T)n→

dEsys.=L(N,T)·dN+M(N,T)·dT;

If the energy function of the system is in the null state, then the following must apply: ∂L/∂T=∂M/∂N→This is the equilibrium point, where Esys.=0,

If the Esys. is unstable: ∂L/∂T≠∂M/∂N, (dependent on pathway and undifferentiable); here the equation ∂L/∂T≠∂M/∂N can be produced independently by forming an equation such as ∂(μ L)/∂T=∂(μ M)/∂N

∂(μ L)/∂T=∂(μ M)/∂N

μ. ∂L/∂T+L.∂μ/∂T=μ∂M/∂N+M. ∂μ/∂N→

M. ∂μ/∂N−L. ∂μ/∂T=μ. ∂L/∂T−μ. ∂M/∂N→

b 1/μ. (M ∂μ/∂N−L ∂μ/∂T)=∂L/∂T−∂M/∂N, für ∂μ(N)t/∂T=0→

(dLn μ/dN). M=(∂L/∂T−∂M/∂N)

There are two alternatives for p by means of variables (N,T).

The (∫g(N)t dN) is the energy change of the system in terms of mass with constant velocity; it is the energy unit of the mass for calculating production.

The (∫f(T)n dT) is the energy change of the system in terms of velocity with constant mass. It is the total energy consumption for entire mass.

The energy change of the system for two independent variables Now, the energy change in terms of mass is kept constant on one side of the closed system:

∂E(T)n/∂Nsys=0→ΔH=B, constant, critical point.

On other side of the system, the energy change is kept constant in terms of velocity.

∂E(N)t/∂Tsys=0→ΔH=D, constant, critical point.

The mass of the system (Nsys) is allowed as a coefficient; there is a large effect on energy production (∫g(N)t.dN); since it is dependent on pathway, ∂E(N)t/∂Nsys=A→ΔH=A. Nsys, one of the critical point can change.

The following should be noted: The dependence of energy (∫g(N)t dN) on mass and the independence of energy (∫f(T)n dT) on mass in the system.

In the consumption phase ΔE(T)n=(∫f(T)n *dT), energy remains constant in terms of mass, and in the production phase ΔE(N)t=(∫g(N)t*dN), energy remains contant in terms of velocity.

ΔEsys=±(ΔEᵢₙᵢₜᵢₐₗ−ΔE_{Final}.)·Nsys→

ΔEsys=±(ΔE(T)n·Nsys−ΔE(N)t·Nsys)→

ΔEsys=±(ΔE(T)n−ΔE(N)t·Nsys);

and Nsys ≠0; quantized by means of ΔE(N)t. with conditions:

If Nsys=ΔE(T)n/ΔE(N)t→ΔEsys=0→∫ƒ(z).dz=0

If Nsys<ΔE(T)n/ΔE(N)t→ΔEsys and ∫ƒ(z).dz have the same sign as ΔE(T)n.

If Nsys>ΔE(T)n/ΔE(N)t→ΔEsys and ∫ƒ(z).dz have the same sign as ΔE(N)t.

This is in the view that the mass is too large and the velocity is too small. Nsys>>Tsys≡0, the pathway is defined only by Nsys. In the view that the mass is too small and the velocity is too large, the pathway is defined only by Tsys;

Tsys>>Nsys.≡0, i.e., this time (∫g(N)t dN) can be assumed as consumption (process) and (∫f(T)n dT) can be assumed as production (controller). The deciding (control) role this time is played here by velocity instead of mass.

ΔEsys=±(ΔE(N)t·Tsys−ΔE(T)n·Tsys)→

ΔEsys=±(ΔE(N)t−ΔE(T)n−Tsys);

Tsys≠0; quantized by means of ΔE(T)n. with conditions::

If Tsys=ΔE(N)t/ΔE(T)n→ΔEsys=0→∫ƒ(z)·dz=0

If Tsys<ΔE(N)t/ΔE(T)n→ΔEsys and ∫ƒ(z)·dz have the same sign as ΔE(N)t.

If Tsys>ΔE(N)t/ΔE(T)n→ΔEsys and ∫ƒ(z)·dz have the same sign as ΔE(T)n.

If both are independent of the pathway:

ΔEsys=±(ΔE(N)t−ΔE(T)n), with conditions:

If ΔE(N)t=ΔE(T)n→ΔEsys=0→∫ƒ(z)·dz=0

If ΔE(N)t<ΔE(T)n→ΔEsys has the sign as ΔE(T)n.

If ΔE(N)t>ΔE(T)n→ΔEsys has the sign as ΔE(N)t.

The other pathways lead the Esys. to zero. Such as: ⊖=N·T (nonlinear pathway) or φ=N/T (linear pathway)→ΔEsys=0→∫ƒ(z)·dz=0.

Further remarks:

We note:

1—If ƒ(z)=E(N,T), thus

dƒ(z)=dEsys.=(∂E/∂N)·dN+(∂E/∂T)·dT

is equally valid, whatever the variables N,T, . . . , independent or dependent on other variables.

2—If E(N,T) ≠0 & E(N,T)=c, a constant, then dE=0 is valid; in this case not all variables N,T, . . . can be independent variables.

3—The expression L(N,T)·dN+M(N,T)·dT is not the differential of E(N,T), if ∂L/∂T ≠∂M/∂N; in this case, there is no exact differential, since the dependence comes into question, and then the discontinuity.

4—In this case, if by means of a method, one creates E(N,T) by separating into two divided functions such as g(N)t and ƒ(T)n, and the interval for g(N)t is taken as [0,a] and the interval for f(T)n is taken as [0,b].

The function ƒ(T)n is treated as an independent continuous function with positive dependent field R. It does not matter which of g(N)t or ƒ(T)n except that both are continuous; we take ƒ(T)n here as continuous.

$$Δ {E}_{initial} = {\int }_{0}^{b} f ( T ) n \cdot d T = B ≡ F ( 0 ) n - F ( b ) n = F ( b ) n ;$$

The function g(N)t is n-times stepwise continuous over the entire pathway, and many can be taken in its interval [0, a] (its interval [0, a] is n partially continuous); function g(N)t is continuous and differentiable in small intervals [0, N1], independent of its small interval. Otherwise, n is partially continuous in [0, a]. Then the small area energy A1 can be calculated by simple geometric law.

A1 is the unit area energy for the entire interval [0, a], for the total distance [0, a]. One can write:

And with the help of the fixed point theory, one can demonstrate that the equation (I) can be equal to zero at one point (B−A1·n=0) (there is a fixed point in the fixed point space); then, with certainty, on the left side of this point, the equation is <0 and on the right side of this fixed point, the equation is >0. The equation: (B−A1·n) can be taken as a substitution or a map for a space Z with J as its fixed point space: such as was stated on the first page, first paragraph.

If one reverses the continuity of the equation, so that ƒ(T)n in the interval [0,b] t is partially independently continuous, ƒ(T)n now lies in the controller space instead of in the process space, and in contrast, this time g(N)t lies independently continuous in the entire interval [0, a] with positive dependent field R in the process space.

(G(a)t−F(T1)n·Ts)>0 if Ts<(G(a)t/F(T1)n)

(G(a)t−F(T1)n·Ts)=0 if Ts=(G(a)t/F(T1)n)

(G(a)t−F(T1)n·Ts)<0 if Ts>(G(a)t/F(T1)n)

(F(b)n−G(N1)t·Ns)>0 if Ns<(F(b)n/G(N1)t)

(F(b)n−G(N1)t·Ns)=0 if Ns=(F(b)n/G(N1)t)

(F(b)n−G(N1)t·Ns)<0 if Ns>(F(b)n/G(N1)t)

For example:

We take as examples the unnatural economic function ƒ(z) with variable W for work and variable M for money.

ƒ(W,M)≡(t(M)w , h(W)m) and [0,b] for t(M)w and [0, a] for h(W)m as their interval. And first we obtain t(M)w as independently continuous in the entire interval [0,b] and h(W)m; w is partially independently continuous in its interval [0, a]:

In a closed system, if both functions are treated with positive dependent field R

(T(b)w+H(a)m)−(H(W1)m·Ws+T(M1)w·Ms)<0

if→Ws>(T(b)w/H(W1)m) and Ms>(H(a)/T(M1)w) or

Ws+Ms>(T(b)w/H(W1)m)+(H(a)m/T(M1)w)=

Ws+Ms>{(T(b)w)·(T(M1)w)+(H(a)m)·(H(W1)m)}/(H(W1)m·T(M1)w)II

An intermediate remark:

This study shows us for an unnatural function system such as the economy capacity permits limiting of the system;

1—Should the entire economic consumtion be obtained large, then continually constant, maximum consumption is constant, first in terms of money with constant work T(b)w, then vice versa, this time in terms of work with constant money H(a)m.

2—The economic production should be broken down in terms of money with constant work T(M1)w, then in terms of work with constant money H(W1)m as the capacity of the system permits. Minimum natural unit production, so one creates that the natural unit obtains its real quantity and conserved amount; then will become aware of how many coefficients should be in the system. that the economy will always be obtained below zero (positive balance). Or vice versa, we first look at how many numerical units exist in the system, such as how many families exist in the group or company, or how many trees in the forest.

One can present the same subject with three variables:

e.g.: If the economy depends on a function with three variables:

W—the work (viewed mathematically, is area freedom of the system)

M—the money (viewed physically and chemically, money is time),

E—the protection of the environment (viewed mathematically, the protection of the environment is defined as the right for every existence outside the existence of self in the system, or, that is, every outside existence).

ƒ(W, M, E)≡ƒ(h(W)_{m,e}, t(M)_{w,e}, q(E)w,m)

H(a)ₘₑ+T(b)_{w,e}−Q(E1)_{w,m}·Es (⊖1)

T(b)_{w,e}+Q(c)_{w,m}−H(W1)_{m,e}·Ws; (⊖2)

Q(C)_{w,m}+H(a)_{m,e}−T(M1)_{w,e}·MS; (⊖3)

From here, as examples, models for providing a closed system by means of the equation:

ΔEsys=(ΔE(T)n−ΔE(N)t Nsys)

with condition:

If Nsys>ΔE(T)n/ΔE(N)t

The so-called standard formation enthalpy ΔH° f (f=formation) can be found for numerous compounds in data collections. These values are preferably indicated for 25° C. Thus, a value of −795.8 kJ/mol is found for ΔH° f for 1 mol of solid calcium chloride. This is identical to the reaction enthalpy (not to the method enthalpy) for the formation of N moles of calcium chloride from the elements (at 25° C.):

NCa(s)+NCl2(g)→NCaCl2(s), ΔH° f=−N795.8 kJ/mol

It should be noted that there is a large difference between reaction enthalpy and method enthalpy. In the case of reaction enthalpy, the energy unit operates in terms of mass with constant velocity, but in the case of method enthalpy, the entire energy operates in terms of velocity with constant mass. The reaction enthalpy is dependent on the mass (pathway), and the method enthalpy is independent of the mass (pathway);

(Product-Educt)−Nsys·(Educt-Product)=0

1. If Nsys ≦ΔH° (Product-Educt)/ΔH° (Educt-Product)→ΔE Sys.≧0

The system takes energy from environment, or it is in equilibrium with the environment.

2. If Nsys ≧ΔH° (Product-Educt)/ΔH° (Educt-Product)→ΔE Sys.≦0

The system yields energy to the environment, or it is in equilibrium with the environment.

For example: CaCl2;

Proof supplied by Hess's law (an energy conservation law).

The total energy balance for a chemical process is independent of the pathway by which the product is formed from the educt.

(We show here that energy is produced, and nevertheless, there is no difference between a large process cycle and a small process cycle; energy remains conserved).

The energy consumption is 4320 kJ/mol for (product-educt) CaCl2 by means of the method enthalpy, such as melting—liquid electrolysis with liquid cathodes, whereas the energy production speaks for (educt-product) CaCl2 by means of reaction enthalpy N.(−795.8 kJ/mol), in a closed system.

If Nsys≧4320/795.8=5.42→energy will be produced in this system.

A large process cycle for CaCl2 in four steps:

1. 5O2 (g)+4P(s)→P4O10(s)+E° Reaction 1

Delta H° R=−2940.1 kJ/mol

2. P4O10(s)+10Ca (g)→P4 (g)+10CaO(s)+E° Reaction 2

Delta H° R=−5133.9 kJ/mol

3. 10CaO(s)+10Cl2(g)→10CaCl2(s)+5O2(g)+E° Reaction 3

Delta H° R=−1607.1 kJ/mol

4. The following are three variants for method electrolysis of CaCl2: A: With variant: calcium-copper alloy (liquid cathode): DeltaH method=4320 kJ/mol; the energy consumption was measured (in Gmelin Part B—Lieferung 1. Sys. −Nu. 28, 1956, p. 24), (in: ULMANN, 3rd ed., vol. 4, 1953, pp. 842, 834)

B: DeltaH° method=2880 kJ/mol with variant: electrolytic production from calcium-lead alloy (Austrian Patent 128790 [1928/32] and German Patent: 458493 [1926/28]).

C: DeltaH° method=3600 kJ/mol with variant: CaCl2+CaF2 (in:G.ANGEL, Swedish Papperstidning 50 No.11 Vol. 1947, p. 20)

In addition to the listed reactions, however, the following reactions should be noted:

P4 (g) 4P(s)

Delta H° R=0−59=59 kJ/mol

10Ca(s)→10Ca (g)

Delta H° R=10 (178.2-0)=1782 kJ/mol

The total energy recovery is in a large round process cycle:

A: for the variant with calcium-copper alloy:

Delta H° Sys.=−9681.1−59+1782+4320=−7958+4320=−3638 kJ/mol

B: for variant with calcium-lead alloy:

Delta H° Sys =−9681.1−59+1782+2880=−7958+2880=−5078.1 kJ/mol

C: for variant with calcium fluoride:

Delta H° Sys.=−9681.1−59+1782+3600=−7958+3600=−4358 kJ/mol

Now the small process cycle for CaCl2 in two steps:

The energy production is for N moles of CaCl2:

NCa(s)+NCl2 (g)→NCaCl2(s)

Delta H° f=−N795.8 kJ/mol (Educt-Product)

And the energy consumption, Delta H° consumed=4320 kJ/mol (Product-Educt)

If N≧4320/795.8≧5.42→In this system energy is produced.

In our case N=10;

A: Delta H° cycle=4320kJ/mol−7958 kJ/mol=−3638 kJ/mol

Here, the importance is in the closed system; if the educt is formed from the product, the energy remains constant for a firmly maintained mass in terms of velocity, and if the product is formed from the educt, the energy remains constant for a firmly maintained velocity in terms of mass, i.e., if one variable can be defined as the pathway, the equilibrium changes, since the quantity or the course condition of the pathway can change.

B: And with variant calcium-lead alloy: If N≧3,6→ΔE Sys.≦0

Delta H° for small cycle=2880 kJ/mol−7958 kJ/mol=−5078 kJ/mol

C: Variant with calcium fluoride: If N≧4.5→ΔE Sys.≦0

Delta H° for small cycle=3600 kJ/mol−7958 kJ/mol=−4358 kJ/mol

Entropy calculation for the process:

1. 5O2 (g)+4P(s)→P4O10(s)+E° Reaction.1 T=25° C.

Delta S° R=−0.96 kJ/mol.K

2. P4O10(s)+10Ca (g)→4P (g)+10CaO(s)+E° Reaction 2 T=25° C.

Delta S° R=−1.119 kJ/mol.K

3. 10CaO(s)+10Cl2(g)→10CaCl2(s)+5O2(g)+E° Reaction 3 T=25° C.

Delta S° R=−0.505 kJ/mol.K

4. A: The following is a method with temperature T=600° C.-650° C.

Delta S° R=Qm/T=4.68 kJ/mol.K

P4 (g) 4P(s)

Delta S° R=−0.116 kJ/mol.K

10Ca(s)→10Ca (g)

Delta S° R=1.13 kJ/mol.K

The total entropy change is in a large round process cycle:

A: for variant with calcium-copper alloy:

Delta S° sys.=−0.96−1.119−0.505−0.116+1.13+4.68=−1.57+4.68=3.11 kJ/mol.K

The entropy production is for small cycle with N moles of CaCl2:

NCa(s)+NCl2 (g) NCaCl2()

Delta S° R=−N 0.157 kJ/mol.K

ΔS cycle=ΣSi

If Nsys≦29.8 in this system,→ΔS Sys.≧0

If Nsys≧29.8 in this system,→ΔS Sys.≦0

In our case N=10

ΔS cycle=4.68−1.57=3.11 kJ/mol.K, which is identical to Delta S° Sys.

The free enthalpy calculation of the process:

1. 5O2 (g)+4P(s)→P4O10(s)+E° Reaction 1 T=25° C.

Delta G° R=−2726 kJ/mol

2. P4O10(s)+10Ca (g)→4P (g)+10CaO(s)+E° Reaction 2 T=25° C.

Delta G° R=−4720 kJ/mol.

3. 10CaO(s)+10Cl2(g)→10CaCl2(s)+5O2(g)+E° Reaction 3 T=25° C.

Delta G° R=−1460 kJ/mol

4. A: The following is a method with temperature T=600° C.-650° C.

Delta G°ᵥ=Delta H−T. Delta S=0.36 kJ/mol

P4 (g)→4P(s)

Delta G° R=−24 kJ/mol

10Ca(s)→10Ca (g)

Delta G° R=1440 kJ/mol

The total free entropy change is in a large round process cycle:

A: for the variant with calcium-copper alloy:

Delta G° Sys.=−7490+0.36=−7489.64 kJ/mol

The free enthalpy production is for a small cycle with N moles of CaCl2:

NCa(s)+NCl2 (g)→NCaCl2(s)

Delta G° R=−N749 kJ/mol

ΔG cycle=ΣGi=0.36−N.749

If N≦0.00048 in this system,→ΔG Sys.≧0

If N≧0.00048 in this system,→ΔG Sys.≦0

In our case N=10

ΔG cycle=0.36−7490=−7489.64 kJ/mol, which is identical to Delta G° Sys.

The large and the small process cycles are identical and the thermodynamic properties show that the process can occur spontaneously, AH process cycle<0; ΔG process cycle<0; ΔS process cycle>0;

We know that the course of a redox reaction can generate electrical energy; vice versa, the introduction of electrical energy can make possible chemical reactions; the energy of such a forced process not running spontaneously is called electrolysis. 1. Faraday Laws:

The precipitated quantity of material is proportional to the charge that has flowed through.

Q=the charge that has flowed

m=precipitated quantity of material

F=Faraday's constant=96500 A·s/mol

Q=F·m→Q/m=F→∂Q/∂m=0→∂E(T)n/∂Nsys=0

The equation shows: Energy is independent of mass.

In the vacuum, photons move at the speed of light in vacuum. The dispersion relation, i.e., the dependence of energy on frequency is linear, and the proportionality constant is Planck's constant.

EPh=Energy of a photon

f=Frequency

λ=Wavelength

C=2.99·!0̂⁸ m/s

h=6.626·10̂⁻³⁴ J·s

P=Pulse of a photon

EPh=h·fPh→E/f=h→∂E(N)t/∂Tsys=0→E(N)t/Tsys=h

The equation shows: Energy is independent of velocity.

This time:

The dependence of energy on mass is linear and the proportionality constant is the second power of the speed of light.

EPh=mPh·Ĉ²→E/m=Ĉ²→E(T)n/∂Nsys=0→E(T)n/Nsys=Ĉ²

The equation shows: Energy is independent of mass.

Under the assumption that the potential energy is constant, in one-dimensional space, the electron only possesses kinetic energy.

In the following examples, you can observe the causes and effects that mass and velocity have in a closed system. (The selected velocity was recorded in the examples of practical study by means of the Downs-Zelle method for production of sodium metal (0.173 kg/s)).

In the examples, I have operated once with firmly maintained mass and different velocities and once with firmly maintained velocity and different masses.

### EXAMPLE 1

In a closed system, Ca(s) is produced by electrolysis of calcium chloride by means of the Ca-Cu alloy method; the energy consumption is 4320 kJ/mol, if the mass flow produced at 0.173 kg/s. The energy maintenance and the production of energy are calculated:

N Ca(s)+N Cl2(g)→N CaCl2(s);

ΔH° R=N (−795.8 kJ/mol)−0=−N 795.8 kJ/mol

ΔEsys.=ΣΔH=4320 (kJ/mol)−Ns·795.8 (kJ/mol)→if

Ns≦5.42→ΔEsys.≧0 and if

Ns≧5.42→66 Esys.≦0; in this case N=4.325

ΔEsys.=ΣΔH=4320 (kJ/mol)−N·795.8 (kJ/mol)=+878.165 8 (kJ/mol)

ΔEsys.=878.165 8 (kJ/mol)·0.173 kg/s·1mol/(4.325·0.04) kg=+878.16 (kW)

The system must take up energy from the environment; in the case of this amount of matter and velocity, a production of energy is not possible, and this was to be expected, since: N<Ns→N−Ns<0 or N/Ns<1; N−Ns=−1.095; N/Ns=0.79

### EXAMPLE 2

Electrical energy consumption is necessary in a closed system that produces the precipitated 1 kg of white phosphorus with a voltage of 8 (V) from molten (P4O10) by electrolysis; and the produced white phosphorus is combined with oxygen by this reaction:

N 4P(s)+N 5O2(g)→N P4O10(s); ΔH° R=−N 2940.1 kJ/mol.
if the mass flow of the white phosphorus is produced at 0.173 kg/s, the energy maintenance calculated.

W=U.I.t→W=U·Q→Q=W/U, A

4P5++20e−→4P

n(P)/n(e−)=4/20=⅕→n(e−)=5. n(P)→Q/F=5. m(P)/M(PI); B→

A, B→W/(U·F)=5·m(P)/(M(P))→W=(5·m(P)·U·F)/(M(P))

W=(5·1 kg·8 v·96500 A·s/mol)/0.031 kg/mol=34.645 kWh for 1 kg of white phosphorus without production time.

W=34.645 kWh/kg=3866.4 kJ/mol

ΔEsys.=ΣΔH=3866.4 kJ/mol−Ns. 2940.1 kJ/mol if:

Ns≦1.315→ΔEsys.≧0 and if

Ns≧1.315→ΔEsys.≦0; in this case N=1.39

ΔEsys.=ΣΔH=−220.34 kJ/mol=−220 kW

N/Ns=1.057; N−Ns=0.057

### EXAMPLE 3

In a closed system, Na(s) metal is produced by the Downs-Zelle method from sodium chloride; the energy consumption was calculated at 993.6 kJ/mol for pure Na(s); and if the mass flow of Na(s) is produced at 0.173 kg/s in the system, the production of energy is calculated in the system.

N Na(s)+N/2 Cl2(g)→N NaCl; ΔH° R=−N 411 kJ/mol

ΔEsys.=ΣΔH=993.6 kJ/mol−Ns. 411 kJ/mol if:

Ns≦2.41→ΔEsys.≧0 and if

Ns≧2.41→ΔEsys.≦0 in this case N=7.52

ΔEsys.=ΣΔH=−2.1 MJ/mol=−2.1 MW, and N/Ns=3.1; N−Ns=5.1.

### EXAMPLE 4

In a closed system, water is decomposed; in modern plants, this electrolysis requires a current energy of 4.5 kWh/Nm̂3 H2 which is equal to 50 kWh/kgH2=360.4 kJ/mol, and the energy production is calculated by means of the reaction enthalpy (−N 285.83 kJ/mol), if the mass flow of the hydrogen molecule is produced at 0.173 kg/s, as it is with energy maintenance in the system.

N H2 (g)+N/2O2 (g)→N H2O (I); ΔH° R=−N 285.83 kJ/mol.

ΔEsys.=ΣΔH=360.4 kJ/mol−Ns.285.83 kJ/mol if:

Ns≦1.26→ΔEsys.≧0 and if

Ns≧1.26→ΔEsys.≦0; in this case N=86.5

ΔEsys.=ΣΔH=−24.36 MJ/mol=−24.36 MW. N/Ns=86.65; N−Ns=85.24

In order to precipitate 1 kg of H2 from this H2O electrolysis within 1 s with a voltage of 1.9 V, which requires electrical energy consumption, and to calculate production of energy in the process cycle:

Q/F=I·t/F=2·m(H2)/M(H2)→I=2·m(H2)·F/(M(H2)t)

I=2.1(kg)·96500(A·s/mol)/(0.002(kg)·1s)=96.5·10̂6 (A)

W=U.I.t=1.9 (v). 96.5·10̂6 (A). 1(s)=183.35·10̂6(v.A.s)=50.93 (kWh) the energy consumption for 1 kg of H2 in one second of production time.

W=50.93 kWh/kg=366.7 kJ/mol; N=500

ΔEsys.=366.7 kJ/mol−Ns. 285.83 kJ/mol=−142.548 MJ/mol=−142.548 MJ/s=MW

The energy production in 1 second by means of 1 kg of H2.

In order to precipitate 1 kg of H2 from the same H2O electrolysis within 1 hour with a voltage of 1.9 V, which requires electrical energy consumption, and to calculate production of energy in the process cycle:

I=26805.5 A

W=U.I.t=1.9 (v). 26805.5 (A). 3600(s)=183.35. 10̂6 (v.A.s)=50.93(kWh) the energy consumption for 1 kg of H2 in one hour of production time.

W=50.93 (kWh)=366.7 kJ/mol, N=500

ΔEsys.=366.7 kJ/mol-Ns. 285.83 kJ/mol=−142.548 MJ/mol=−142.548 MJ/h=−39 kW;

The energy recovery in 1 hour by means of 1 kg of H2.

It makes no difference whether 1 kg of mass is produced within 1 s or 1 h; energy remains constant (conserved) with a firmly maintained mass in terms of velocity ∫f(T)n dT; but it does matter, on the other hand, process cycle—closed system, if energy remains constant (conserved) with a firmly maintained velocity in terms of mass (∫g(N)t* dN). There are two different behaviors of energy, and in a closed system, the two behaviors cannot always produce (control) or consume (process) the same quantity, since different pathway behaviors indicate that one can remain constant while the other is variable.

The theory:

In a closed system, if one part of the system remains continuous due to small change with a constant variable, then it provides the limits for the course condition of the variable change (pathway), that with small change the equilibrium state of the system is transformed to the other side of the equilibrium state (fsys.≧0 is transformed to fsys≦0).

I want to now state the path is as important as the technique.

1. A method for measuring change in closed system is hereby characterized in that, (the thesis): the partial differential equation the closed system ƒ(z) as a substitution or map onto a fixed point space such as closed band gap J,
ƒ(z): J→J gives g=ƒ(g) if g εJ,
if this partial differential equation ƒ(z) contains the partial derivatives of a function system in several variables
ƒ(z)=ƒ(N,T,E, ∂E/∂N, ∂E/∂T, . . . )
such as function E(N,T) in two independent variables, could be on a closed pathway.
$${\int }_{Initial}^{Final .} f ( z ) \cdot d z \neq 0$$

2. The method according to claim 1, further characterized in that (explanation of the theory) in a closed system, if one part of the system remains continuous due to small change in the case of a constant variable, then it provides the limits for the course condition of the variable change (pathway), that with small change the equilibrium state of the system is transformed to the other side of the equilibrium state (fsys.≧0 is transformed to fsys≦0).

3. The method according to claim 1, further characterized in that the equation for the function system ƒ(z)=ƒ(x1, x2, . . . ,xn):
$$\begin{matrix}( the entire consumption in the process space ) + ( the unit production in the controller space ) ( Number of the unit x 1 ) \\ in terms of x 2 , … xn in terms of x 1 \\ + \\ \begin{matrix}( the entire consumption in the process space ) + ( the unit production in the controller space ) ( Number of the unit x 2 ) \\ in terms of x 1 , … xn in terms of x 2\end{matrix} \\ + \\ ∘ \\ ∘ \\ ∘ \\ + \\ n\end{matrix}$$

4. The method according to claim 1, further characterized in that a closed system with n (n>1) part variable is not a dead system.

5. The method according to claim 1, further characterized in that this closed system can be viewed as an n-divided function.

6. The method according to claim 1, further characterized in that for each function, one variable remains variable and all the other variables remain constant.

7. The method according to claim 1, further characterized in that for each function there is one change equation for the entire system.

8. The method according to claim 1, further characterized in that the equation system is identical:

9. The method according to claim 1 further characterized in that all of the entire consumption in terms of all of the variables that are constant.

10. The method according to claim 1, further characterized in that all of the unit production in terms of the changed variable.

11. The method according to claim 1, further characterized in that claim 10 multiplied by its number (coefficient).

12. The method according to claim 1, further characterized in that all of the claims are also valid for open system.
